(19) United States
(12) Patent Application Publication
(10) Pub. No.: US 2007/0204992 A1
(43) Pub. Date: Sep. 6, 2007

(54) POLYURETHANE PROPPANT PARTICLE AND USE THEREOF

(75) Inventors: STEPHEN DAVIS, Mill Bay, AB (CA); THOMAS WILLIAM ANTHONY DEVEREUX, Edmonton, AB (CA)

Correspondence Address: BENNETT JONES;C/O MS ROSEANN CALDWELL, 4500 BANKERS HALL EAST, 855 - 2ND STREET, SW, CALGARY, AB, T2P 4K7, CA

(73) Assignee: DIVERSIFIED INDUSTRIES LTD., Sidney (CA)

(21) Appl. No.: 11/622,911

(22) Filed: Jan. 12, 2007

Related U.S. Application Data
(60) Provisional application No. 60/766,374, filed on Jan. 13, 2006.

(51) Int. Cl. E21B 43/267; C09K 8/80

(52) U.S. Cl. 166/280.2; 507/924; 507/219; 428/402; 428/407

(57) ABSTRACT

The present invention relates to a novel proppant particle comprised of polyurethane resin. More specifically, these particles are of low density, yet have a sufficiently high compressive strength to be useful as proppants in downhole oil and gas operations. The present invention also relates to a method of using the proppant particle in downhole oil and gas operations including well completion and stimulation operations, for example hydraulic fracturing of subterranean formations.

### CROSS REFERENCE TO RELATED APPLICATIONS

This application is entitled to the benefit of Provisional Application Ser. No. 60/766,374, filed on Jan. 1, 2006.

### FIELD

The invention relates to proppants for use in downhole oil and gas operations including well completion and stimulation operations, for example hydraulic fracturing of subterranean formations. In particular, this invention relates to the composition and use of proppants of low specific gravity.

### BACKGROUND ART

Hydraulic fracturing is a technique commonly used in the oil and gas industry to enhance production of oil and gas from subterranean formations. In a typical fracturing operation, hydraulic pressure is applied to the formation by introducing fracturing fluid or “carrier fluid” into subterranean hydrocarbon containing formations at high pressures to create or enlarge fractures in a reservoir. Proppant is injected with the fracturing fluid. When the hydraulic pressure is released the proppant particles hold the fractures open, enhancing the ability of the fractures to conduct fluids from the formation to the well bore. Ceramic proppants typically have a high specific gravity of 2.6-3.2. This high specific gravity causes the proppants to tend to settle out from the carrying fluid. To reduce this tendency, the fluid that transports the proppant is formulated with gels and other additives that increase the ability of the fluid to carry the proppant into the formation.

The physical properties of the proppant are important for an effective fracturing operation. The particles must be of the correct size range, must resist the closure pressure of the fracture, the aggressive fluid environment and mechanical abrasion forces. The quality of proppant particles are commonly assessed by standard American Petroleum Institute tests, conducted by, for example, Stim Labs Inc. of Duncan, Okla.

A light weight proppant with a specific gravity close to that of the fracturing fluid, for example a specific gravity of 1.2-1.5, while retaining the other properties defined in the American Petroleum Institute proppant tests, enhances the efficiency of fracturing operation well improvement. Additionally, a lightweight proppant reduces the additive requirements for the fracturing fluid and increases the controlled placement of the proppant in fractures, resulting in improvement in well stimulation efficiency.

The benefits of using lightweight proppants in the fracturing procedure are described in the literature, e.g. in U.S. Pat. No. 6,772,838. Lightweight proppants are disclosed in Jones et al., in U.S. Pat. No. 4,547,468, wherein hollow ceramic spheres were used to reduce the density of the particles. Beck et al., in U.S. Pat. No. 4,493,875, used a ceramic coated with hollow glass bubbles, and Bienvenu, in U.S. Pat. No. 5,531,274 used polymeric resin materials that are inherently light. More recently, the use of resins to form a light particle by coating lightweight cores has been disclosed in e.g. Dawson et al., U.S. Pat. No. 6,772,838 and McDaniel et al., U.S. Pat. No. 6,582,819.

### SUMMARY OF THE INVENTION

The present invention involves a novel proppant particle comprised of polyurethane resin, wherein the particle passes the API RP 56 test at 4000 psi or greater.

In another aspect, the invention is a method of fracturing a subsurface earth formation having a wellbore, comprising: injecting into the wellbore a fluid at sufficiently high rates and pressures such that the formation fails and fractures to accept the fluid; mixing a proppant particle into the fluid being injected into the wellbore, wherein the proppant particle is comprises a polyurethane resin; and filtering out the proppant from the fluid so as to produce a packed mass of particles adjacent the fracture, which packed mass will prop open the fracture thereby allowing produced fluids to flow towards the wellbore.

### DESCRIPTION OF THE INVENTION

Disclosed herein is a proppant particle comprising polyurethane resin. The particle may consist entirely of polyurethane resin, or polyurethane resin may represent the predominant structural material in the particle. This suitability of the particle disclosed herein, as a proppant, is made possible by the properties of the polyurethane resin that is used to make the particle. The applicants have found that Version™, filament winding grade resin, obtained from RS Technologies (Resin Systems Inc.), Calgary, Alberta, Canada is a suitable polyurethane resin useful to make the proppant particle disclosed herein. As used herein, “polyurethane resin” is the Version™, filament winding grade resin, obtained from RS Technologies (Resin System Inc.), or another polyurethane resin that can be used to make proppant particles with the characteristics disclosed herein.

The proppant particle disclosed herein is of similar compressive strength to available commercial proppants, yet it has a specific gravity that is more comparable to that of the fracturing fluids. The proppant particle disclosed herein has a crush strength or crush resistance that passes the API RP56 test at 4,000 psi or greater.

The proppant particle disclosed herein meets or exceeds the requirements of API Standard RP 56 and API Standard RP 60.

The specific gravity of the proppant particle may range from about 0.5 to about 2, alternatively from about 0.5 to about 1.5, alternatively from about 1 to about 1.5, alternatively from about 1.1 to about 1.4 and alternatively from about 1.2 to about 1.3. In one embodiment the proppant particle has a specific gravity in the range of 1.1-1.2.

Those of skill in the art will understand that selection of suitable specific gravity for the proppant particle will depend, in part, on the specific gravity of the carrier fluid and on whether it is desired that the selected proppant be relatively lightweight or substantially neutrally buoyant in the selected carrier fluid, and/or the desired gel properties of the carrier fluid.

The proppant particle may be comprised entirely of polyurethane resin. In another embodiment the proppant particle may be comprised of a polyurethane resin mixed with a filler material. This filler material may be, for example, talc, fly ash, glass microspheres, zeolites, or a combination thereof. In another embodiment, the proppant particle may be a composite particle, for example made of fibre-reinforced polyurethane resin.

The above described proppant particle may further comprise a coating layer made with materials that can be bound together by a binder. Such materials include sand, talc, zeolites or similar materials. The coating layer may comprise fibrous compounds, such as glass fibres, polymer fibres or mineral fibres. The coating layer may comprise compounds of a cementitious nature, such as Portland cement. Any of the above mentioned coating compounds may be used alone or in combination with one another.

In another embodiment, the proppant particle may be comprised of a core that does not comprise the polyurethane resin, which core is coated with a coating layer that comprises the polyurethane resin. The core may be, for example, a hard, dense core, a porous core, or a core plus microspheres. Examples of hard dense cores are sand, fired ceramics such as alumino silicates in the form of clays, bauxite, quartz or similar minerals. Examples of porous cores are flyash, or other particles that have voids therein to make them porous. Microspheres are small hollow glass spheres that may be used to make voidage. They may be bound together with a binder to make a small spherical core for the proppant particle. Useful binders include sodium silicate or bentonite or similar such compounds.

The coating layer may further comprise, in addition to the polyurethane resin, additional compounds, for example materials that can be bound together by a binder. Such materials include sand, talc, zeolites or similar materials. Or, the coating layer may also comprise fibrous compounds, such as glass fibres, polymer fibres or mineral fibres. Or, the coating layer may also comprise compounds of a cementitious nature, such as Portland cement. Any of the above mentioned additional compounds may be used alone or in combination with one another, and with the polyurethane resin.

In another embodiment, the proppant particle may be formed as a multilayer structure, with alternating layers of polyurethane resin and the other materials such as those described above.

The size of the proppant particle size may be varied. As is apparent, the size is selected based on a number of factors, such as the anticipated downhole conditions. It will be understood with benefit of this disclosure that proppant particle size may be selected by those of skill in the art to meet and withstand anticipated downhole conditions of a given application. In one embodiment, the size range of the proppant particle may be −20+40 mesh, and in another embodiment −10+20 mesh, according to ASTM mesh sizes.

The proppant particle may be manufactured using methods of manufacture for creating particles, which are known to those skilled in the art. Proppant particles may be made by hand casting resin drops onto a flat surface. The particles will have a substantially spherical shape, with a flat surface on one side. Commercial production of the proppant particle may be accomplished by use of suitable equipment for small particle manufacture, such as a fluid bed coater. The proppant particle may also be manufactured by use of a prilling tower. The composition of the proppant particle may further be adjusted to achieve a droplet solidification time that matches the requirements of the equipment.

Particles may be coated, or layering may be accomplished, by using commercially available equipment, such as a fluid bed coater or a rotary drum coater, as is known by those of skill in the art.

Also disclosed herein are well treating methods (e.g., hydraulic fracturing, gravel packing and/or sand control) that may be employed to treat a well penetrating a subterranean formation, and that include introducing the proppant particle of the present invention into the well.

The proppant particle may be used with a variety of carrier fluids. These carrier fluids may have a reduced gelling requirement as compared to carrier fluids employed with conventional proppant materials.

In one embodiment, the proppant particle may be introduced or pumped into a well as neutrally buoyant particles in, for example, a completion or workover brine comprised of saturated sodium chloride solution carrier fluid or any other carrier fluid that is known in the art, for example, having a specific gravity of from about 1 to about 1.5, alternatively from about 1.2 to about 1.5, further alternatively about 1.2, thus eliminating or substantially reducing the need for, for example, gelling agents.

The proppant particle/carrier fluid mixture may be employed at conventional temperatures and compression pressures experienced in well completion and stimulation operations. It will be understood with benefit of this disclosure that the proppant particle composition may be varied, and may be selected by those of skill in the art to meet and withstand anticipated downhole conditions of a given application.

While the invention has been described in conjunction with the disclosed embodiments, it will be understood that the invention is not intended to be limited to these embodiments. On the contrary, the invention is intended to cover alternatives, modifications and equivalents, which may be included within the spirit and scope of the invention as defined by the appended claims. Various modifications will remain readily apparent to those skilled in the art.

1. A proppant particle comprising a polyurethane resin, wherein the particle passes the API RP 56 test at 4000 psi or greater.

2. The proppant particle of claim 1 wherein the particle has a specific gravity of between 1.0 and 1.5.

3. The proppant particle of claim 1, wherein the particle has a specific gravity of between 1.1 and 1.2.

4. The proppant particle of claim 1 wherein the particle has a size of −20+40 mesh or −10+20 mesh

5. The proppant particle of claim 1 wherein the particle further comprises a filler.

6. The proppant particle of claim 5, wherein the filler is selected from the group consisting of: fly ash, talc, glass microspheres, zeolite, and any mixtures thereof.

7. The proppant particle of claim 1, further comprising at least one coating layer that comprises at least one compound selected from the group consisting of: (a) compounds that can be bound together by a binder, (b) fibrous compounds and (c) cementitious compounds.

8. The proppant particle of claim 7, wherein the compound that can be bound together by a binder is selected from the group consisting of: sand, talc and zeolites.

9. The proppant particle of claim 7, wherein the fibrous compound is selected from the group consisting of: glass fibres, polymer fibres and mineral fibres.

10. The proppant particle of claim 7, wherein the cementitious compound is Portland cement.

11. The proppant particle of claim 1, comprising a core that does not comprise the polyurethane resin, which core is coated with at least one coating layer that does comprise the polyurethane resin.

12. The proppant particle of claim 11, wherein the core is one of: (a) a hard, dense core, or (b) a porous core.

13. The proppant particle of claim 12, wherein the hard dense core is a ceramic core, a bauxite core, a sand core or a quartz core.

14. The proppant particle of claim 12, wherein the porous core is a flyash core, or a core comprising microspheres.

15. The proppant particle of claim 11, wherein the at least one coating layer further comprises at least one compound selected from the group consisting of: (a) compounds that can be bound together by a binder, (b) fibrous compounds and (c) cementitious compounds.

16. The proppant particle of claim 15, wherein the compound that can be bound together by a binder is selected from the group consisting of: sand, talc and zeolites.

17. The proppant particle of claim 15, wherein the fibrous compound is selected from the group consisting of: glass fibres, polymer fibres and mineral fibres.

18. The proppant particle of claim 15, wherein the cementitious compound is Portland cement.

19. A method of fracturing a subsurface earth formation having a wellbore, comprising:
(a) injecting into the wellbore a fluid at sufficiently high rates and pressures such that the formation fails and fractures to accept the fluid;
(b) mixing a proppant particle into the fluid being injected into the wellbore, wherein the proppant particle is comprises a polyurethane resin; and
(c) filtering out the proppant from the fluid so as to produce a packed mass of particles adjacent the fracture, which packed mass will prop open the fracture thereby allowing produced fluids to flow towards the wellbore.

20. The method of claim 19, wherein the proppant particle passes the API RP56 test at 4000 psi or greater.

21. The method of claim 20, wherein the proppant particle has a specific gravity of between 0.5 and 2.0.

22. The method of claim 20, wherein the proppant particle has a specific gravity of between 1.1 and 1.2.

23. The method of claim 19, wherein the proppant particle has a size of −20+40 mesh or −10+20 mesh

24. The method of claim 19, wherein the proppant particle further comprises a filler.

25. The method of claim 24, wherein the filler is selected from the group consisting of: fly ash, talc, glass microspheres, zeolite, and any mixtures thereof.

26. The method of claim 19, wherein the proppant particle further comprises at least one coating layer.

27. The method of claim 26, wherein the coating layer comprises at least one compound selected from the group consisting of: (a) compounds that can be bound together by a binder, (b) fibrous compounds and (c) cementitious compounds.

28. The method of claim 19, wherein the proppant particle comprises a core that does not comprise the polyurethane resin, which core is coated with at least one coating layer that does comprise the polyurethane resin.

29. The method of claim 28, wherein the core is one of: (a) a hard, dense core, or (b) a porous core.

30. The method of claim 29, wherein the hard dense core is a ceramic core, a bauxite core, a sand core or a quartz core.

31. The method of claim 29, wherein the porous core is a flyash core, or a core comprising microspheres.

32. The method of claim 28, wherein the at least one coating layer further comprises at least one compound selected from the group consisting of: (a) compounds that can be bound together by a binder, (b) fibrous compounds and (c) cementitious compounds.

33. The method of claim 32, wherein the compound that can be bound together by a binder is selected from the group consisting of: sand, talc and zeolites.

34. The method of claim 32, wherein the fibrous compound is selected from the group consisting of: glass fibres, polymer fibres and mineral fibres.

35. The method of claim 32, wherein the cementitious compound is Portland cement.
